(19) United States
(12) Patent Application Publication
(10) Pub. No.: US 2016/0366537 A1
(43) Pub. Date: Dec. 15, 2016

(54) EXTENDED DISTANCE BLUETOOTH (R) LOCATION DEVICE

(71) Applicant: LE VISE PRODUCTS, LLC, Plano, TX (US)

(72) Inventor: WILLIE TSAI WU, FAIRVIEW, TX (US)

(73) Assignee: LE VISE PRODUCTS, LLC, PLANO, TX (US)

(21) Appl. No.: 14/735,167

(22) Filed: Jun. 10, 2015

(51) Int. Cl. H04W 4/00

(52) U.S. Cl. CPC H04W 4/008; H04W 4/02

(57) ABSTRACT

The invention relating to an extended distance Bluetooth® location device designed for children, pets, or persons with mental incapacity is provided herein. More particularly, a location device is disclosed that utilizes amplified Bluetooth® signals and GPS technology to communicate an exact location the location device to a handheld receiver, all while extending the range of standard Bluetooth® radio signal transmissions, optimizing energy usage, and enabling both indoor and outdoor use of the device.

### BACKGROUND OF INVENTION

1. Field of the Invention

This invention relates to transportable location devices, particularly suited for tracking the location of young children, pets, or persons with mental incapacity such as autism or dementia. Such location device includes tracking and monitoring technology in conjunction with a handheld device to determine the location of the bearer of the location device.

2. Description of Related Art

Location devices are used in a variety of settings. A particular use of location devices involves tracking and location of children, pets, or persons with mental incapacity. For example, several inventions have been disclosed wherein a wrist band, watch, or badge is affixed to the child. Such wrist band, watch, or badge communicates electronically with a tracking device held by a parent or guardian of the child. These types of location devices have been available since the early 2000's. For instance, Patent Application Publication 2004/0199382 describes a device that utilizes Global Positioning System (GPS) technology that communicates with a computer or cellular phone to locate a child.

Over the years, this technology has improved. For example, U.S. Patent Application Publication 2012/0223834 describes a watch that monitors the child's location using GPS technology and alerts the tracking device if the child exceeds a distance threshold. A similar device has also been contemplated for use with mentally challenged persons such as autistic children (US Patent Application Publication US 2013/0260785). An advantage of GPS technology is that the exact location of the GPS receiver can be determined through triangulation of signals broadcasted from multiple satellites.

Although GPS is a viable technology for determining location, it also has drawbacks. First, a typical GPS receiver must have direct, unobstructed view of the sky in order to receive communications broadcasted from GPS satellites. If the GPS receiver is inside a house, building, airport, train station, shopping mall and other location, it will not receive the broadcasts from the GPS satellites. Second, if a smartphone handheld device is utilized to determine the location of the GPS device, the system typically only works if the smartphone has cellular service. The GPS receiver determines its location based on signals from the GPS satellite, but typically utilizes cellular signals to transmit the location back to the cellular device. Finally, due to the information processing required, GPS receivers typically suffer from high battery usage.

As a low power alternative to GPS, radio transmission technology (Bluetooth®) has been used to transmit information over short distances, typically less than 10 meters. By increasing the power of radio transmissions from the Bluetooth® device, the range of the transmissions can be expanded far beyond the typical 10 meter range.

Bluetooth® enabled devices do not have to be in visual line of sight of each other, but a quasi-optical wireless path must be available; Bluetooth® devices do not need a direct view of the sky and are typically designed for indoor conditions, but a wall or large obstacle can obstruct the radio transmissions between the devices. Additionally, unlike GPS-based location devices, Bluetooth® based devices are not designed to track the exact location of the receiver.

Optimally, location devices designed for pets, or persons with mental incapacity should work inside and outside and provide the exact location of the device. Neither GPS nor Bluetooth® technologies alone can provide this functionality. In 2013, a patent application was filed with the Canadian Intellectual Property Office (CA 2831534) was filed that utilizes Bluetooth® technology for short distances and GPS technology for longer distances.

While innovations are beginning to address the downsides of each technology, technological advances are still needed to provide a single device that 1) determines the actual location of the device when location information is available, 2) optimizes power consumption during both inside and outside use, 3) automatically extends the distance of Bluetooth® radio transmissions, and 4) does not require cellular service to transmit signals from the location device to the handheld device.

### BRIEF SUMMARY OF THE INVENTION

An extended distance Bluetooth® location device designed for children, pets, or persons with mental incapacity is provided herein. The location device can be incorporated into any wearable or transportable item such as a wrist band, watch, badge, or child's toy.

The disclosed location device utilizes Bluetooth® radio transmission technology to communicate with a handheld receiver. Such device dynamically utilizes a power amplifier to boost the signal to expand the Bluetooth® signal range. When communications between a handheld receiver and the location device have ceased using standard Bluetooth® transmissions, the device intelligently engages the power amplifier to boost the signal and increase the Bluetooth® transmission range. Although Bluetooth® is the preferred wireless transmission signal, if desired, other wireless signal transmission technologies such as Wi-Fi could be used for communications between the location device and the handheld receiver.

Although the extended distance Bluetooth® location device does not rely on cellular transmissions to communicate with the handheld receiver, it utilizes GPS satellite broadcasts to determine its location. The determined location is transmitted back to the handheld receiver using the Bluetooth® transmissions. Use of the GPS technology to determine the precise location of the location device can be engaged automatically by the location device or dynamically by the bearer of the handheld receiver.

Other features and advantages of the present invention will become apparent from the following more detailed description, taken in conjunction with the accompanying drawings, which illustrate, by way of example, the principles of the presently described apparatus and method of use.

### BRIEF DESCRIPTION OF THE SEVERAL VIEWS OF THE DRAWING(S)

The accompanying drawings illustrate various exemplary implementations and are part of the specification. The illustrated implementations are proffered for purpose of example, not for purpose of limitation.

Illustrated elements will be designated by numbers. Once designated, an element will be identified by the identical number throughout. Illustrated in the accompanying drawings is at least one of the best mode embodiments of the present disclosure. In such drawings:

FIG. 1 is a block diagram showing communication between the extended distance Bluetooth® location device and a handheld device such as a cellular phone;

FIG. 2 is a diagram illustrating the operation of the extended distance Bluetooth® location device transmission methods (Bluetooth® and amplified Bluetooth®). In the preferred design, standard Bluetooth® radio transmissions are used for location signals at close range. Outside the standard Bluetooth® range, an amplifier increases the strength of the signal, thereby increasing the range of the Bluetooth® signal. FIG. 2 also illustrates signals constantly broadcasted by GPS satellites that are received by the wrist band location device;

FIG. 3 is a block diagram of the extended distance Bluetooth® location device; and

FIG. 4 is a front isometric view of an implementation of a wrist band for containing the extended distance Bluetooth® location device.

### DETAILED DESCRIPTION OF THE INVENTION

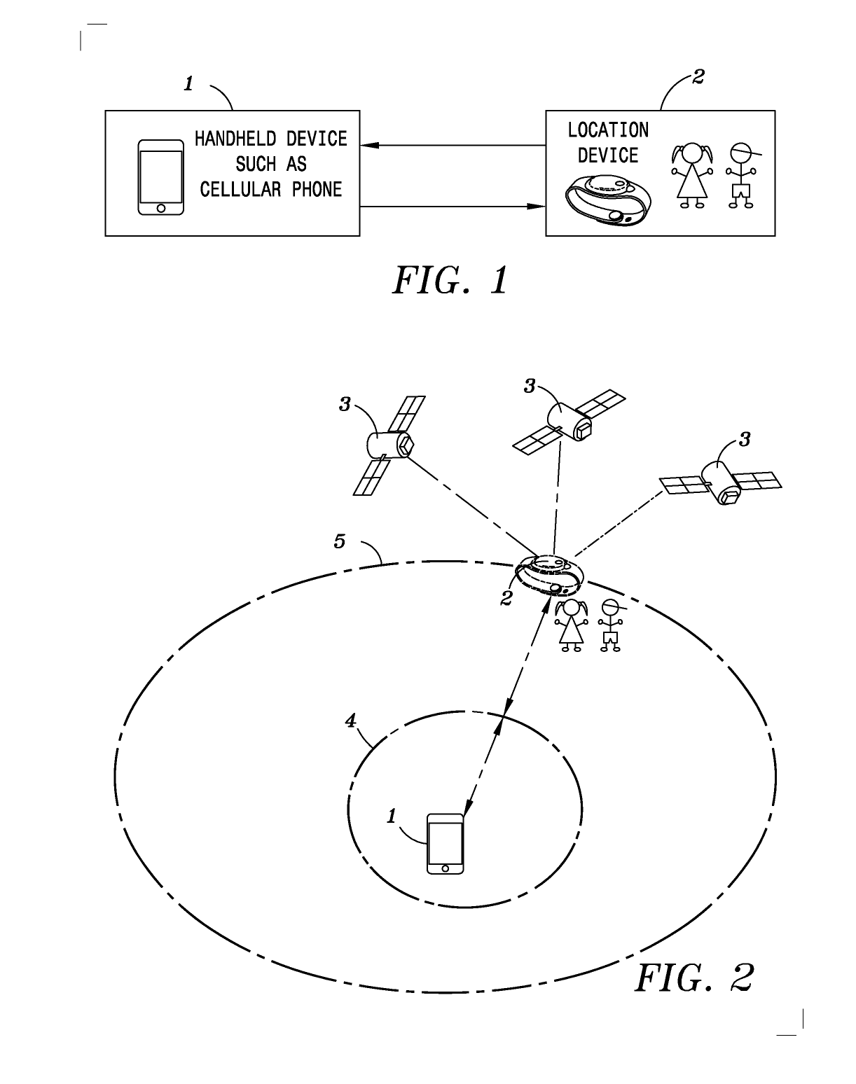

The extended distance Bluetooth® location device will be more fully understood and appreciated by reading the following Detailed Description in conjunction with the accompanying drawings, wherein like reference numerals refer to like components. FIG. 1 through FIG. 5 illustrate an embodiment of the present invention.

Referring to FIG. 1, the extended distance Bluetooth® location device (2) utilizes wireless transmissions to communicate with handheld device (1). Optimally, the location device is contained in a flexible wrist band as shown in FIG. 4, but it may also be incorporated into a watch, badge, toy, or other easily transportable vessel. Handheld device (1) is preferably an easily transportable device that can receive signals from location device (2), such as a cellular phone or smart phone. However, other devices may also receive signals from the location device such as proximity devices, tablets, smart watches, portable media player, and laptop computers.

Handheld device (1) incorporates a computer program including a graphical user interface to enable the bearer of handheld device (1) to monitor and control communications with location device (2). Optimally, the computer program is a downloadable app that can be easily installed on handheld device (1).

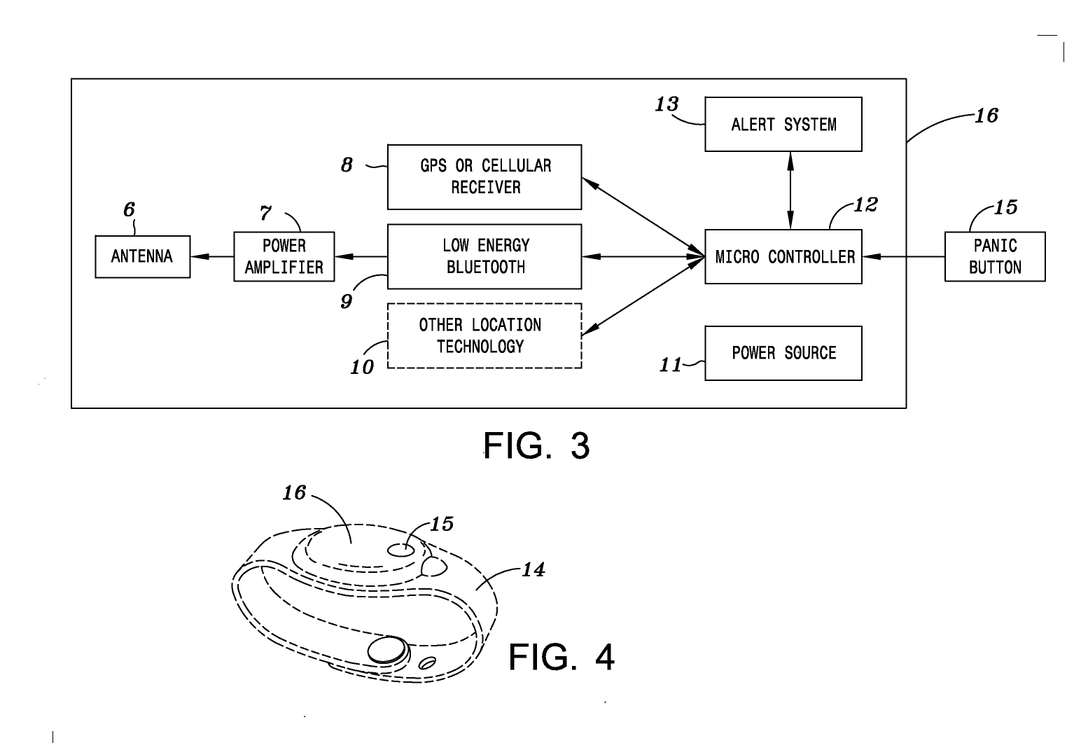

In the present design, wireless communication between location device (2) and handheld device (1) is accomplished through Bluetooth® radio signal transmissions sent at regular intervals. Handheld device (1) and location device (2) utilize a “handshake” algorithm to maintain communication between each device. If a signal sent from the handheld device (1) is not confirmed by a return signal from location device (2), handheld device (1) alerts the bearer of handheld device (1) that location device (1) is out of range. Similarly, if location device (1) does not receive expected signals from handheld device (1), location device (1) assumes that it has exceeded its normal range and automatically engages power amplifier (7), shown in FIG. 3, to boost the power of its signal in an attempt to re-establish communication with handheld device (1). Although Bluetooth® radio transmissions are the preferred communication method, other wireless communication means are possible such as Wi-Fi, infrared signals, and cellular signals.

FIG. 2 illustrates the standard and extended Bluetooth® signal ranges of location device (2). Under normal operation, standard low energy Bluetooth® signals are utilized to provide short range communication (4) between location device (2) and handheld device (1). If short range communication (4) becomes unavailable, the handheld device (1) generates an alert, then power amplifier (7) is engaged to boost the power of the Bluetooth® signals to provide extended range communication (5).

Standard low energy Bluetooth® communications can be lost for a variety of reasons. Ordinarily, the signal could be lost because location device (2) has exceeded the range of standard Bluetooth® transmissions. However, large obstacles and other outside interference can also disrupt the low energy Bluetooth® signals. Engaging power amplifier (7) to boost the Bluetooth® signal can enable extended range communication (5), but it can also can help to overcome obstacles and interference within the short range communication (4) range.

FIG. 2 also illustrates broadcasted GPS satellite transmissions (3). Broadcasted GPS satellite transmissions (3) are received at regular intervals by location device (2).

FIG. 3 illustrates the conceptual design of location device (2). The location device consists of antenna (6), power amplifier (7), GPS receiver (8), low energy Bluetooth® receiver (9), micro controller (12), power source (11), and outer casing (16).

Micro controller (12) contains computer programming and intelligently operates location device (2). As described below, micro controller (12) controls global positioning system receiver (8), herein referred to as “GPS receiver”, low energy Bluetooth® receiver (9), and other technology receivers (10) based on its computer programming.

GPS receiver (8) constantly receives GPS satellite broadcasts and transmits those signals to micro controller (12). Location device (2) utilizes the GPS signals to determine its exact location. However, location device (2) utilizes Bluetooth® transmissions to communicate with handheld device (1) rather than cellular signals.

Additionally, GPS receiver (8) can be turned on or off automatically or manually to conserve energy. Optimally, micro controller (12) automatically turns the GPS receiver (8) off under normal conditions to conserve energy where short range communication (4) is possible; micro controller (12) automatically engages GPS receiver (8) when extended range communication (5) is required. Alternatively, location device (2) can operate in a high energy use mode at all times, wherein GPS receiver (8) is constantly engaged. As a second alternative, the bearer of handheld device (1) may cause handheld device (1) to send a signal to location device (2) to manually engage GPS receiver (8).

Communication between location device (2) and handheld device (1) is primarily conducted through antenna (6) and low energy Bluetooth® receiver (9). Micro controller (12) may also engage power amplifier (7) to boost the signal power of the Bluetooth® transmissions.

Similar to GPS receiver (8), power amplifier (7) is turned on or off automatically to conserve energy. Optimally, micro controller (12) automatically turns power amplifier (7) off under normal conditions to conserve energy where short range communication (4) is possible; micro controller (12) automatically engages power amplifier (7) when extended range communication (5) is required.

Power source (11) provides energy for location device (2). Optimally, power source (11) is a long life rechargeable battery.

Location device (2) can be optionally augmented with other technology receivers (10) to enable reception of other signal transmission types, such as Wi-Fi, infra-red, or cellular signals.

Location device (2) may incorporate an alert system (13) for notifications to the bearer of location device (2). Alert system (13) may generate notifications automatically, such as when location device (2) is no longer receiving transmissions from handheld device (1). The bearer of handheld device (1) may also manually send transmissions to location device (2) causing alert system (13) to notify the bearer of location device (2). Such notifications may be communicated to the bearer of location device (2) audibly (i.e. beep), visually (i.e. blinking light), or through tactile means (i.e. vibration).

All the internal components of location device (2) are housed in an outer casing. Such casing should be made of tough, tamper-proof material that resists corrosion. Optimally, such outer casing (16) is waterproof and provides water protection for the internal components of location device (2).

Micro controller (15) is electronically connected to panic button (15). When the bearer of location device (2) engages panic button (15), a signal is transmitted to micro controller (15). Micro controller (15) then sends an emergency signal to low energy Bluetooth® receiver, which then relays the emergency signal to handheld device (1).

As shown in FIG. 4, location device (2) can be optimally incorporated into a flexible wrist band (14). However, location device (2) may alternatively be incorporated into any easily transportable object, such as a watch, badge, or child's toy.

The extended distance Bluetooth® location device disclosed herein is predominantly suited for tracking the location of young children, pets, or persons with mental incapacity such as autism or dementia. Additionally, the location device is particularly valuable for use in flexible wrist bands attached to the person being tracked. The location device sends signals to a handheld device, which may be a “smart phone” that is programmed to receive and process the information.

Although the present invention has been described with respect to specific details, it is not intended that such details be regarded as limitations on the scope of the invention, except to the extent that they are included in the accompanying claims. It will thus be appreciated that those skilled in the art will be able to devise numerous alternative arrangements that, while not shown or described herein, embody the principles of the invention and thus are within its spirit and scope.

I claim:

1. An extended distance Bluetooth® location device, comprising:
a global positioning system receiver;
a low energy Bluetooth® receiver;
an antenna for sending and receiving Bluetooth® signals;
a power amplifier;
a micro controller adapted to receive signals from said global positioning system receiver and said low energy Bluetooth® receiver, transmit signals through said low energy Bluetooth® receiver, and automatically engage said power amplifier and said global position system receiver when expected signals are not received from said low energy Bluetooth receiver;
a power source; and
an outer casing to hold said global positioning system receiver, said low energy Bluetooth® receiver, said antenna, said power amplifier, said micro controller, and said power source.

2. The extended distance Bluetooth® location device of claim 1, wherein said micro controller is further adapted to accept signals from said low energy Bluetooth® receiver directing it to manually engage said global positioning system receiver.

3. The extended distance Bluetooth® location device of claim 1, wherein said micro controller is further adapted to automatically notify an alert system when expected signals are not received from said low energy Bluetooth receiver.

4. The extended distance Bluetooth® location device of claim 3, wherein said alert system generates auditory, visual, or tactile notifications in response to notifications from said micro controller.

5. The extended distance Bluetooth® location device of claim 1, wherein said micro controller is further adapted to:
accept signals from a panic button electronically connected to said extended distance Bluetooth® location device; and
in response, automatically send emergency signals to said low energy Bluetooth® receiver.

6. The extended distance Bluetooth® location device of claim 1, wherein said outer casing is water resistant.
